(19) United States
(12) Patent Application Publication
(10) Pub. No.: US 2006/0248172 A1
(43) Pub. Date: Nov. 2, 2006

(54) Method for updating software of an electronic control device by flash programming via a serial interface and corresponding automatic state machine

(76) Inventors: Thomas Zurawka, Stuttgart (DE); Joerg Schaeuffele, Erligheim (DE)

Correspondence Address: KENYON & KENYON LLP, ONE BROADWAY, NEW YORK, NY, 10004, US

(21) Appl. No.: 10/561,111

(22) PCT Filed: Jun. 24, 2004
(86) PCT No.: PCT/DE04/01326

§ 371 Date: Apr. 26, 2006

(30) Foreign Application Priority Data
Jun. 24, 2003 (DE) 103 28 241.6

(51) Int. Cl. G06F 15/177

(52) U.S. Cl. 709/220

(57) ABSTRACT

A method for executing a software update of a control unit by flash programming a flash memory of the control unit having multiple segments via a serial interface, demands on the flash programming procedure being established, a sequence of the flash programming procedure being specified by a finite-state machine which defines states and transitions of the software, and availability, security, and reliability requirements of each state and each transition of the finite-state machine being checked. In addition, described are a corresponding finite-state machine and a computer program for automatically checking the availability, security, and reliability requirements.

### FIELD OF THE INVENTION

The present invention relates to a method for executing a software update of an electronic control unit using flash programming via a serial interface.

### BACKGROUND INFORMATION

Flash memory is increasingly used as memory technology for program stock and data stock in electronic control units. This memory technology makes a software update of the control units possible by reprogramming the respective flash memory of the control units via serial interfaces. The serial interface may be, for example, a central off-board diagnostic interface of a vehicle via which the flash memory of an electronic control unit of the vehicle is reprogrammed using what is known as a flash programming tool. A software update is thus possible without removing the respective electronic control unit from the vehicle, which results in considerable cost savings compared to a control unit exchange or removal. In the described type of flash programming, high security and reliability demands must be met, in particular with regard to vehicle service as well as in the area of safety-relevant electronic control units.

Only entire flash segments of a flash memory may be deleted or reprogrammed in currently used flash technologies. A smallest, physically associated, completely deletable or programmable memory unit of the flash memory is referred to as a segment. Therefore, the deleting and programming steps for flash segments should be differentiated in flash programming. Moreover, it should be taken into consideration that it is not possible to simultaneously export one program from a flash segment while another flash segment of the same flash module is reprogrammed. Therefore, the program sections for controlling the programming process for a flash module must be, at least temporarily during the execution of flash programming, swapped out into another memory module of the control unit, e.g., into another flash module or a free RAM (random access memory) section.

The limited transmission capacity of the off-board diagnostic interface results in quite long flash programming times in large flash memories of electronic control units. Therefore, shortening the flash programming times is a frequent demand in production and service.

Furthermore, for liability reasons attention should be paid in flash programming that unauthorized flash programming or flash programming using manipulated program or data stock is to be prevented to the greatest possible extent. Finally, it should be pointed out that flash programming via the mentioned off-board diagnostic interface may take up a relatively long period of time. Aborts of the programming procedure due to possibly occurring interferences may be anticipated at any time. Such interferences are, for example, failure of the voltage supply of a vehicle or of the flash programming tool, incorrect response of other network control units, interruption of the communication link between the electronic control unit to be programmed and the flash programming tool used for this purpose, or an operating error. A failed authentication and signature check may also result in the abort of the flash programming procedure. It may be necessary to be able to ensure the availability or an immediate restart of the flash programming procedure at any time.

### SUMMARY

In one example embodiment, a method for executing a software update of a control unit by flash programming a flash memory of the control unit having multiple segments via a serial interface is provided. The demands to be made on the flash programming procedure are established in a first step of the method, in such a way that a flash programming procedure is specified by a finite-state machine which defines the states and transitions of the software of the control unit and that finally availability, security, and reliability requirements of each state and each transition of the finite-state machine are checked.

Different operating states are preferably initially specified for the software of the control unit when the demands to be made on the flash programming procedure are established. A differentiation is preferably made between a “starting state,” a “normal state,” and a “software update state” in this context. Furthermore, the transitions between the above-mentioned operating states and the transition conditions are defined. In a further example embodiment of the method, memory arrays of the software of the control unit, which are relevant for the flash programming procedure, are divided into programmable and non-programmable memory arrays and components of the software to be reprogrammed are correspondingly assigned to the memory arrays. Furthermore, the memory arrays of the software may be assigned to a memory of the control unit, in particular one programmable memory array to a segment of the flash memory and one non-programmable memory array to a ROM (read only memory) of the electronic control unit. The limited transmission capacity of the off-board diagnostic interface results in quite long flash programming times in large flash memories. It may therefore be desirable to shorten the flash programming times, which is possible, for example, by reducing the flash segments to be reprogrammed. This is preferably achieved by flash programming individual software functions or by a separate flash programming procedure for the program stock and data stock of the electronic control unit. The program stock is frequently already programmed during control unit production, while the data stock is programmed later, e.g., at the end of production of a vehicle in a vehicle-specific manner. As a result, the boot block, the program stock, and the data stock are each stored in segments of the flash memory of the control unit in a further example embodiment of the method according to the present invention. This means that different software functions as well as the program stock and data stock are stored in different flash segments. All program sections of the control unit, which are needed for communication between the control unit and a flash programming tool via the off-board diagnostic interface during a flash programming procedure, must be stored, together with corresponding flash programming routines, in a flash loader in the ROM of the electronic control unit or in a different additional flash segment. The program sections, which are needed for the communication between the control unit and the flash programming tool, are divided into programmable and non-programmable sections, i.e., a base extent stored in the ROM and referred to in the following as the start-up block, and a base extent stored in the flash memory and referred to in the following as the boot block. The start-up block and boot block together provide the software functionality of a microcontroller of the control unit necessary for flash programming via an off-board diagnostic interface. A division into start-up block and boot block may be expedient for a number of reasons. The boot block itself may be reprogrammed if it is stored, as described, in the flash memory. Furthermore, the current status of a flash programming procedure may be stored in a non-erasable manner in the boot block so that, for example, a restart is possible after an abort of the flash programming procedure. The unchangeable base functionality of the start-up block and an identifier for a hardware variant of the electronic control unit may be stored in the more cost-effective and non-reprogrammable ROM of the control unit. According to the present invention, the program stock and the data stock are each stored in a different segment of the flash memory.

Security, reliability, and availability requirements of the flash programming procedure to be executed may be provided by a further preferred embodiment of the method according to the present invention. A transition of a microcontroller of the control unit to the “software update” operating state is initiated by a flash programming tool. In addition to possibly necessary plausibility checks, such as the check for engine shutdown in engine controllers, which must be carried out prior to completion of a driving program and a transition to the “software update” operating state, additional security measures are necessary when used in production and service. According to this, it is necessary for liability reasons, for example, that unauthorized flash programming or flash programming using manipulated program or data stock is to be prevented to the greatest possible extent. Such flash programming procedures should at least be detected and verified.

Flash programming access is generally protected by two different encryption methods. One method is authentication which corresponds to a check of the actual access permission and is carried out subsequent to a plausibility check. A digital key is used to check whether a user of the flash programming tool is actually permitted to execute a software update. A second encryption method is what is known as a signature check. The data consistency of program stock or data stock to be reprogrammed is checked here.

During the signature check, a flash programming tool uses a further digital key to check whether the program stock or the data stock to be reprogrammed matches the control unit hardware and whether the program stock or data stock to be reprogrammed has been improperly manipulated after delivery by the vehicle manufacturer to the service organization, for example. Only after successful completion of the mentioned check should the actual deletion and programming of the respective segments of the flash memory be enabled or unblocked. Unblocking takes place here using the above-mentioned boot block. During specification of the security and reliability requirements for flash programming, it should be ensured that the signature of a microcontroller of the control unit is calculated subsequent to flash programming, on the basis of the program stock and data stock actually programmed into the flash memory in order to detect errors during programming. After a successful signature check, this calculated signature is stored in the flash memory. In addition, special memory structures, i.e., program stock and data stock logistics, are stored in the flash memory as part of the program stock and data stock. Only after a successful signature check, the boot block unblocks the activation of the new program, a drive program, for example.

Moreover, the availability requirement of the flash programming procedure is preferably specified in the method according to the present invention. Since flash programming via the off-board diagnostic interface may take up a relatively long period of time despite the above-described optimization measures, aborts of the programming procedure due to interferences may generally be anticipated at any time. Such interferences are, for example, failure of a voltage supply of a vehicle or of a flash programming tool, incorrect responses of other network control units, interruptions of the communication link between the electronic control unit and the flash programming tool used, or operating errors. Generally, failed authentication and failed signature checks also result in an abort of the flash programming procedure. Therefore, it may be important for a design of the flash programming procedure to ensure the availability of the flash programming procedure under all possible circumstances. This means, for example, that after an abort, a restart of the programming procedure should be ensured anytime in all situations. In a further preferred example embodiment of the method according to the present invention, substates, adoptable in the “software update” operating state, transitions between them, and transition conditions are specified by the finite-state machine during execution of the flash programming procedure. The substates may be the “abort/error message” substate or the “completion/success message” substate. Furthermore, substates for authentication and signature check as well as substates for the deletion and programming of segments of the flash memory may preferably be specified. Moreover, may be desirable to specify substates for the swapping-out and flash programming of the boot block. Transitions between the mentioned substates and corresponding transition conditions are also specified according to the present invention.

Furthermore, the present invention includes a computer program made up of program code elements via which predefined availability, security, and reliability requirements of each state and each transition of an above-described finite-state machine are checked automatically when the program code elements are run on a computer or on a computer system.

Finally, the present invention relates to a method for flash programming an above-described boot block. A method is provided for flash programming a boot block which provides the software functionality necessary for executing the flash programming. The boot block is stored in a first segment of a flash memory. In a first step, the old boot block to be reprogrammed is copied into a free RAM section. The still active old boot block is swapped out into another memory module of the control unit during flash programming, which means that the boot block should be relocatable. In a second step, the old boot block is subsequently activated in the RAM and deactivated in the flash memory where it is stored in a first segment. Furthermore, the new boot block is temporarily stored in a second segment of the flash memory. This step includes deletion of the second segment of the flash memory, programming of the new boot block into the second segment of the flash memory, and a signature check for the new boot block in the second segment of the flash memory. After an abort during these method steps, the flash programming procedure may be restarted using the valid, old boot block in the first segment of the flash memory. In a further step of the method according to the present invention, the new boot block is finally programmed by copying the second segment of the flash memory into the first segment of the flash memory. This step includes deletion of the first flash segment, programming of the new boot block into the first flash segment by copying the second flash segment into the first flash segment, and a signature check for the new boot block in the first flash segment. After an abort during these method steps, the flash programming procedure may be restarted using the valid, new boot block in the second flash segment. One boot block, which is valid for restarting the flash programming procedure, is always preferably marked in the flash memory. This validity marker itself must be stored in a non-erasable manner in the flash memory so that a restart is possible using this information. In a last step of the example method according to the present invention, the new boot block is subsequently activated in the first segment of the flash memory and the old boot block is simultaneously deactivated in the RAM.

### BRIEF DESCRIPTION OF THE DRAWINGS

Further advantages and preferred embodiments of the present invention are explained in greater detail on the basis of the following figures.

FIG. 1 shows a schematic representation of a specification of memory arrays of a control unit relevant for flash programming according to an example embodiment of a method according to the present invention.

FIG. 2 shows a schematic representation of a specification of security requirements and measures according to a further embodiment of a method according to the present invention.

FIG. 3 shows a schematic representation of states and transitions of a boot block during flash programming of the program stock and data stock of an electronic control unit.

FIG. 4 shows a schematic representation of the sequence of an example embodiment of a method according to the present invention for executing flash programming of a boot block.

### DETAILED DESCRIPTION OF EXAMPLE EMBODIMENTS

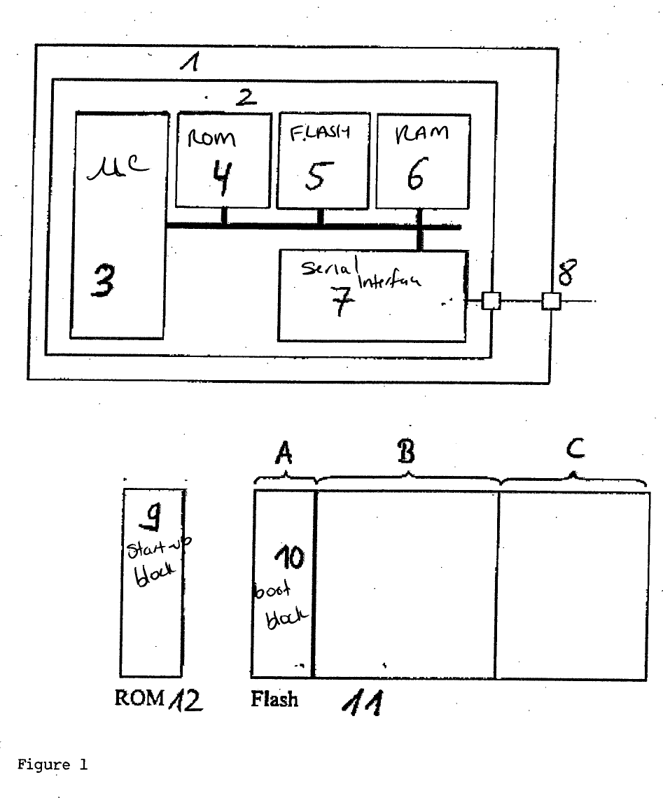

FIG. 1 shows an allocation of memory arrays of a software of a control unit for executing a software update of a control unit by flash programming. A control unit 1 having a microcontroller 2 is shown. Microcontroller 2 has a microprocessor 3 and three different memories, namely a ROM (read only memory) 4, a flash memory 5, and a RAM (random access memory) 6. In addition, control unit 1 has a serial interface 7 for coupling to an off-board diagnostic interface 8 via which a flash programming tool may be connected. A memory allocation of memory arrays of the software of control unit 1, relevant for the flash programming procedure, is shown in the lower part of FIG. 1. The memory arrays are divided into programmable and non-programmable memory arrays and software components to be reprogrammed are correspondingly assigned to the memory arrays. Program sections of microcontroller 2, which are used for communication between microcontroller 2 and a flash programming tool via off-board diagnostic interface 8 during flash programming, are divided into start-up block 9 and boot block 10. Start-up block 9 and boot block 10 together provide the software functionality of microcontroller 2 used for flash programming via off-board diagnostic interface 8. The division into start-up block 9 and boot block 10 is expedient for a number of reasons. Boot block 10 itself, which is stored in a segment A of flash memory 11 in the present case, may be reprogrammed. Moreover, the current status of the flash programming procedure may be stored in a non-erasable manner in boot block 10, making a restart possible after an abort, for example. In contrast, the unchangeable base functionality of start-up block 9 may be stored in more cost-effective and non-reprogrammable ROM 12. The program stock is stored in a further segment of the flash memory, i.e., a flash segment B, and the data stock is stored in a flash segment C.

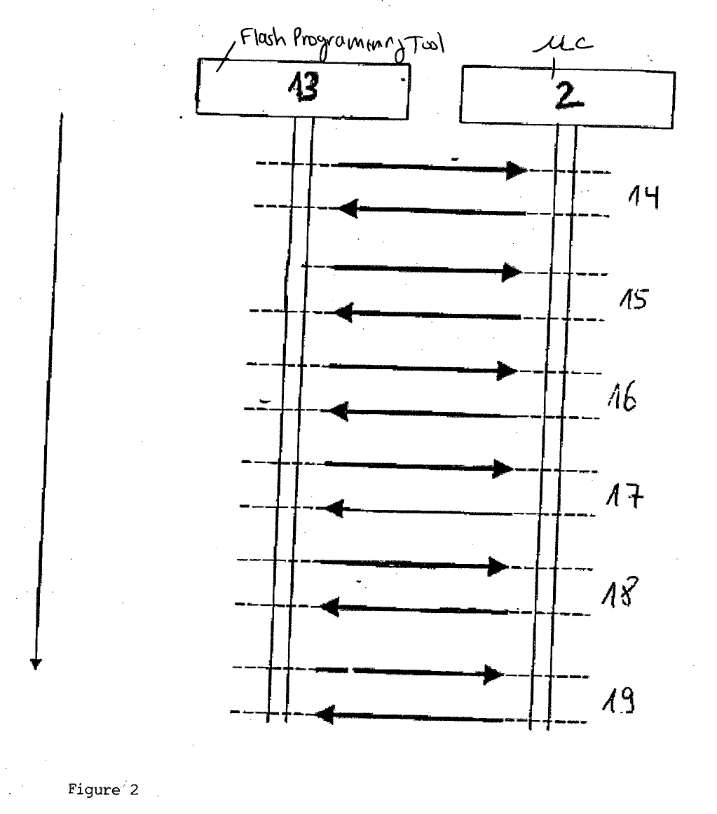

FIG. 2 shows a specification of security requirements during execution of a flash programming procedure. A possible communication sequence between a flash programming tool 13 and a microcontroller 2 of a control unit is shown. After plausibility check 14, which is carried out via an inquiry on the part of flash programming tool 13 and feedback by microcontroller 2 and should be executed prior to a transition to the “software update” operating state, a check is carried out with regard to the actual access authorization. This step is referred to as authentication 15. A digital key is used to check whether a user of flash programming tool 13 is authorized to conduct a software update. The data consistency of the program or data stock to be reprogrammed is checked in a further test step 16. This step is also referred to as the signature check. Based on a further digital key, flash programming tool 13 checks whether the program or data stock to be reprogrammed matches the control unit hardware and whether the program or data stock to be reprogrammed has been improperly manipulated since its delivery. The flash segments are deleted in a step 17 and the corresponding flash segments are subsequently programmed in a step 18 only after successful completion of the check. After flash programming, the signature is calculated by microcontroller 2 based on the program stock and data stock actually programmed in the flash memory in order to be able to detect errors which occurred during programming. This calculated signature check is stored in the flash memory after successful signature check 19. For this purpose, special memory structures, known as program stock and data stock logistics, are stored in the flash memory as part of the program stock and data stock. The boot block only unblocks activation of the new program, such as a drive program, after a successful signature check 19.

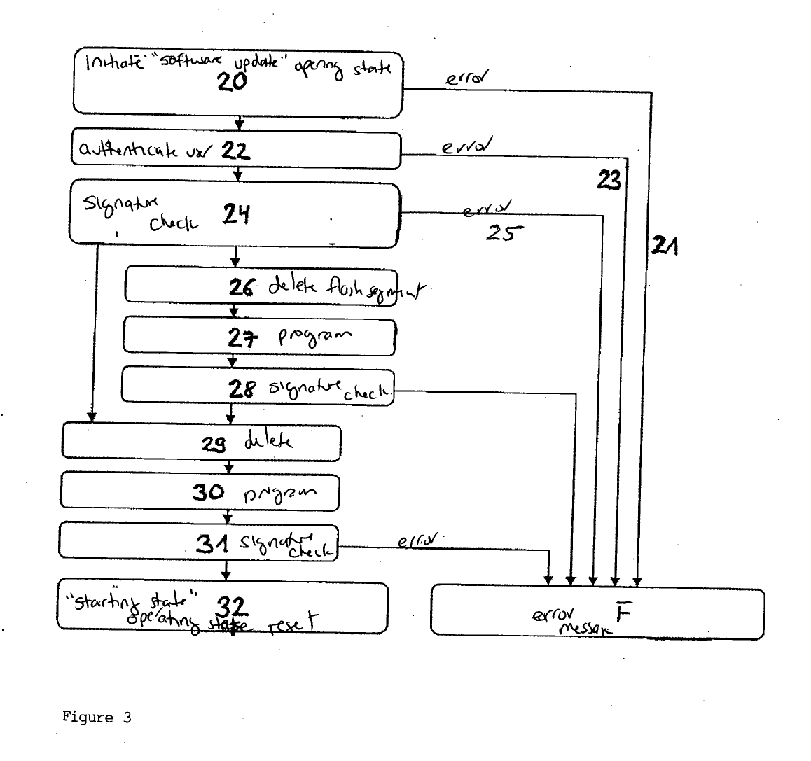

FIG. 3 shows in a schematic representation the state and transitions of a boot block during flash programming of the program stock and data stock. First, during coupling of a flash programming tool to the microcontroller via an off-board diagnostic interface, the control unit is identified in a step 20 and a transition of the microcontroller into the “software update” operating state is initiated. If an error is detected in a step 21, the programming procedure is immediately aborted with simultaneous output of an error message F. The user of the coupled flash programming tool is authenticated in a further step 22. Here also, the programming procedure is aborted accompanied by an error message F if an error is detected in a step 23. This is followed by a signature check 24 which is accompanied by a check of the data consistency via hardware/program stock/data stock logistics. Here also, a detected error 25 is signaled by an abort and accompanying error message F. After execution of these steps, deletion 26 of the flash segment, in which the program stock is stored, takes place; the new program stock is subsequently programmed in a step 27 and a signature check 28 for the new program stock is carried out. The same steps are carried out in steps 29, 30, 31 with regard to flash programming of the data stock. If an error is detected during the signature check for the program stock and the data stock, an abort takes place here also accompanied by an error message F. However, if no errors are detected, the microcontroller is transitioned to the “starting state” operating state via a reset in a step 32.

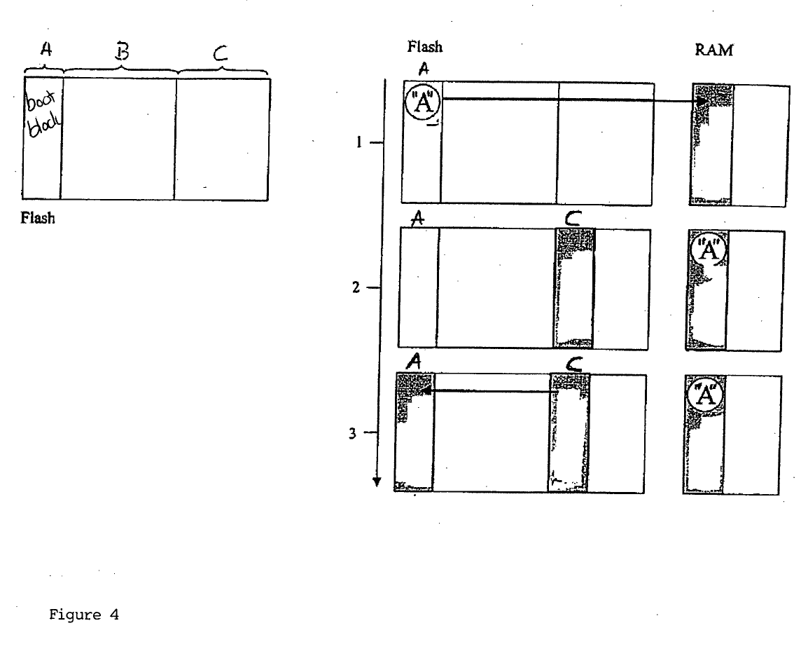

FIG. 4 shows method steps during flash programming of a boot block. During flash programming, active boot block “A” is initially swapped out into a different memory module of the microcontroller, i.e., boot block “A” is relocatable. This may take place, for example, by copying boot block “A” into a RAM section which is free during the flash programming procedure. Boot block “A” is subsequently exported from the RAM. Restart of the programming procedure should be possible, even after failed flash programming of the boot block. An error-free boot block is sufficient for maintaining availability after an abort. The old boot block “A” is copied into a free RAM section in a first step of the method. The old boot block is activated in the RAM in a second step which is indicated by the “A” marking and deactivated in the flash memory. The new boot block is temporarily stored in a flash segment C. Flash segment C is initially deleted, the new boot block is programmed into flash segment C, and a signature check for the new boot block in flash segment C is carried out. After an abort during these method steps, the flash programming procedure may be restarted using the valid, old boot block in flash segment A. The new boot block is programmed in a third step, which is carried out by copying flash segment C into flash segment A. This step includes deletion of flash segment A, programming of the new boot block into flash segment A by copying flash segment C into flash segment A, and a signature check for the new boot block in flash segment A. After an abort during these method steps, the flash programming procedure may be restarted using the valid, new boot block in flash segment C. The currently valid boot block in the flash memory should be marked. This validity marker should be stored in a non-erasable manner in the flash memory so that a restart is possible using this information.

1-12. (canceled)

13. A method for executing a software update of a control unit by flash programming a flash memory of the control unit having multiple segments, via a serial interface, comprising:
establishing requirements to be set for the flash programming;
establishing a flash programming sequence using a finite-state machine which defines states and transitions of the software; and
checking availability, security, and reliability requirements of each state and each transition of the finite-state machine.

14. The method as recited in claim 13, wherein the states and transitions of the software include different operating states including a “starting state,” a “normal state,” and a “software update,” transitions between the operating states, and transition conditions.

15. A method as recited in claim 13, wherein memory arrays of the software of the control unit, which are relevant for flash programming, are divided into programmable and non-programmable memory arrays, and software components to be reprogrammed are correspondingly assigned to the memory arrays.

16. The method as recited in claim 15, wherein the memory arrays of the software are each assigned to a memory of the control unit, one programmable memory array being assigned to at least one segment of the flash memory and one non-programmable memory array being assigned to a ROM of the control unit.

17. The method as recited in claim 13, wherein a boot block, which provides software functionality necessary for executing the flash programming procedure, a program stock and a data stock are stored in segments of the flash memory of the control unit, and a start-up block, which provides software functionality necessary for executing the flash programming procedure, is stored in a ROM of the control unit.

18. The method as recited in claim 13, wherein security, reliability and availability requirements of the flash programming procedure are specified.

19. The method as recited in claim 14, wherein the “software update” state includes substates, transitions between the substates, and transition conditions.

20. A finite-state machine for executing a software update of a control unit by flash programming, comprising:
an arrangement which defines all substates of the software of the control unit, transitions between the substates, and transition conditions adoptable during execution of the software update; and
an arrangement which specifies permanent, non-erasable storage of a last-valid state or an error-free run state in response to the occurrence of a fault during execution of the software update.

21. The finite-state machine as recited in claim 20, wherein substates for authentication and signature check and substates for the deletion and programming of segments of the flash memory are specified as “abort/error message” and “completion/success message” substates.

22. A memory device storing a computer program, the computer program comprising program code elements via which predefined availability, security, and reliability requirements of each state and each transition of a finite-state machine are automatically checked when the program code elements are executed on a computer or on a computer system, the finite-state machine comprising:
an arrangement which defines all substates of the software of the control unit, transitions between the substates, and transition conditions adoptable during execution of the software update; and
an arrangement which specifies permanent, non-erasable storage of a last-valid state or an error-free run state in response to the occurrence of a fault during execution of the software update.

23. A method for executing flash programming of a boot block which provides software functionality necessary for executing the flash programming procedure and is stored in a first segment of a flash memory, the method comprising:
copying an old boot block to be reprogrammed into a free section of a second memory;
activating the old boot block in the second memory and deactivating the old boot block in the flash memory;
temporarily storing a new boot block in a second segment of the flash memory;
programming the new boot block by copying the second segment into the first segment; and
activating the new boot block in the first segment and deactivating the old boot block in the second memory.

24. The method as recited in claim 23, wherein one boot block is always marked in the flash memory as a valid boot block for restarting the flash programming procedure.
